(19) United States
(12) Patent Application Publication
(10) Pub. No.: US 2024/0214829 A1
(43) Pub. Date: Jun. 27, 2024

(54) Wireless consumer-electronic devices with levitation capabilities

(71) Applicant: Plume Design, Inc., Palo Alto, CA (US)

(72) Inventors: Mateusz Bajorski, Wroclaw (PL); Kiran K. Edara, Cupertino, CA (US)

(21) Appl. No.: 18/146,247

(22) Filed: Dec. 23, 2022

(51) Int. Cl. H04W 16/20; H02J 50/90; H04W 16/22

(52) U.S. Cl. CPC H04W 16/20; H02J 50/90; H04W 16/225; H04W 88/04

(57) ABSTRACT

Wireless consumer-electronic devices, such as Wi-Fi access points, are provided in the present disclosure in addition to systems in which one or more wireless consumer-electronic devices are incorporated. A wireless consumer-electronic device, according to one implementation, includes an outer housing and electronic circuitry arranged within the outer housing for performing one or more electronic functions. The wireless consumer-electronic device further includes a power source arranged within the outer housing, where the power source is configured to be charged wirelessly. Also, the wireless consumer-electronic device includes a movement action mechanism arranged within the outer housing, where the movement action mechanism is configured to enable the wireless consumer-electronic device to levitate.

### FIELD OF THE DISCLOSURE

The present disclosure generally relates to wireless devices and networks. More particularly, the present disclosure relates to wireless consumer-electronic devices having both electronic functionality and levitation capabilities.

### BACKGROUND OF THE DISCLOSURE

Wi-Fi networks (i.e., wireless local area networks (WLAN) based on the IEEE 802.11 standards) are ubiquitous, and the primary network used in homes. In fact, Wi-Fi is the most common technique for user device connectivity, and the applications that run over Wi-Fi are continually expanding. For example, Wi-Fi is used to carry all sorts of media, including video traffic, audio traffic, telephone calls, video conferencing, online gaming, and security camera video. Often traditional data services are also simultaneously in use, such as web browsing, file upload/download, disk drive backups, and any number of mobile device applications. That is, Wi-Fi has become the primary connection between user devices and the Internet in the home or other locations. The vast majority of connected devices use Wi-Fi for their primary network connectivity. As such, there is a need to ensure applications run smoothly over Wi-Fi. There are various optimization techniques for adjusting network operating parameters such as described in commonly assigned U.S. patent application Ser. No. 16/032,584, filed Jul. 11, 2018, and entitled “Optimization of distributed Wi-Fi networks,” the contents of which are incorporated by reference herein.

Wi-Fi is continuing to evolve with newer generations of technology, including IEEE 802.11a, 802.11b, 802.11g, 802.11n, 802.11ac, and 802.11ax (referred to as Wi-Fi 6/6E), and future Wi-Fi 7. Each generation of technology evolves the Wi-Fi Media Access Control (MAC) and Physical (PHY) layers to add more capabilities. In the case of IEEE 802.11ax, orthogonal frequency-division multiple access (OFDMA) has been added as a technique aimed at improving the efficiency of Wi-Fi communication when many small packets are being transmitted to or from multiple client devices. OFDMA can operate both in the downlink (one access point communicating simultaneously to multiple clients), or in the uplink (multiple clients communicating simultaneously to a single access point).

In a much more generalized respect, it is typically known that one or more Wi-Fi devices may be used for establishing a Wi-Fi network. For example, one type of Wi-Fi device is a Wi-Fi router, modem, or gateway device that is configured to connect the Wi-Fi network to the Internet. Another type of Wi-Fi device is an Access Point (AP) device that may be used for wirelessly communicating signals between user devices and the Wi-Fi router. AP devices may also be referred to as leaf devices, pods, mesh point devices, hubs, nodes, etc. Generally, most Wi-Fi devices, include AP devices, are built more for function rather than looks. Therefore, the typical paradigm for setting up a Wi-Fi network normally includes the customer purchasing or obtaining the equipment and then setting up the Wi-Fi devices in some out-of-the-way spot that is hidden from view. As long as the Wi-Fi network is working properly, the equipment may essentially be forgotten. However, one problem with this type of arrangement is that normally these out-of-the-way locations are not ideal for optimizing the potential coverage or accessibility with respect to the Wi-Fi network. Usually, this “hidden” Wi-Fi equipment may actually experience greater inference from walls, furniture, etc. Therefore, there is a need in the field of manufacturing Wi-Fi devices to create these devices with better or more pleasing looks so that they can be placed in more prominent locations of a coverage area. Therefore, by designing these devices with such aesthetics that they can be “showcased,” so to speak, the Wi-Fi device can be positioned where user devices can experience greater signal strength with less interference.

### BRIEF SUMMARY OF THE DISCLOSURE

The present disclosure relates to wireless consumer-electronic devices, such as Wi-Fi access points and the like, and systems and networks in which one or more wireless consumer-electronic devices may be arranged. A wireless consumer-electronic device, according to one implementation, includes an outer housing and electronic circuitry arranged within the outer housing for performing one or more electronic functions. The wireless consumer-electronic device further includes a power source arranged within the outer housing, where the power source is configured to be charged wirelessly. Furthermore, the wireless consumer-electronic device includes a movement action mechanism arranged within the outer housing, where the movement action mechanism is configured to enable the wireless consumer-electronic device to levitate.

In some embodiments, the electronic circuitry may include Wi-Fi communication capabilities. The outer housing may therefore include a common size and/or shape of a Wi-Fi device. The wireless consumer-electronic device, for example, may be an Access Point (AP) device, a Wi-Fi pod device, a Wi-Fi leaf device, a Wi-Fi extender, or the like, and may be configured to extend the range of Wi-Fi accessibility by communicating Wi-Fi signals intermediately between a user device and a Wi-Fi router over backhaul and fronthaul links.

Also, the movement action mechanism may further be configured to enable the wireless consumer-electronic device to rotate while in a levitated position. The movement action mechanism, in some embodiments, may be configured to operate in conjunction with a base station device for levitating and rotating the wireless consumer-electronic device. The wireless consumer-electronic device may further include one or more antennas and one or more radios. The movement action mechanism and base station device may therefore be configured to rotate the wireless consumer-electronic device in order to strategically steer the one or more antennas for increasing the strength of wireless communication signals, for increasing wireless coverage, and/or for reducing signal interference.

In addition, the power source of the wireless consumer-electronic device may include a rechargeable battery unit may be configured to operate in conjunction with the base station device for charging the rechargeable battery unit. For example, the power source and base station device may utilize magnetic induction for charging the rechargeable battery unit.

In some embodiments, the movement action mechanism may be configured to move the wireless consumer-electronic device in vertical and horizontal directions to enable self-positioning of the wireless consumer-electronic device within an area. The electronic circuitry of the wireless consumer-electronic device may include wireless communication capabilities. The movement action mechanism may therefore be configured to move the wireless consumer-electronic device to a location and/or orientation for increasing the strength or coverage of wireless communication signals and/or for reducing wireless communication interference. In some embodiments, the wireless consumer-electronic device may further include one or more sensors for sensing obstacles while the movement action mechanism is moving the wireless consumer-electronic device. The electronic circuitry may therefore include navigation functionality to help the movement action mechanism avoid the sensed obstacles. The action of self-positioning the wireless consumer-electronic device may include landing the wireless consumer-electronic device on a base station device selected from one or more base station devices to enable the power source to be wirelessly recharged.

In still further embodiments, the wireless consumer-electronic device may further include a speaker driver arranged within the outer housing. When the wireless consumer-electronic device is positioned on an external object having a flat surface, the speaker driver may be configured to vibrate the external object to generate sound. The electronic circuitry may further include a microphone and smart assistance circuitry for enabling a user to speak instructions in order to cause the electronic circuitry to automatically perform one or more actions, such as placing a phone call, accessing the Internet, monitoring a security system, monitoring one or more Internet of Things (IOT) devices, controlling lights, controlling the volume of a speaker system, etc.

The outer housing of the wireless consumer-electronic device may be devoid of electrical ports. Also, the wireless consumer-electronic device may further include one or more audio and/or visual output devices configured to indicate when a power level of the power source is low, when the strength of a wireless link is low, and/or when an Internet connection is down.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1A is a diagram illustrating a perspective view of a levitating system according to various embodiments.

FIG. 1B is a diagram illustrating a perspective view of the levitating system of FIG. 1A where a wireless consumer-electronic device is shown levitating and/or hovering above a surface of a base station, according to various embodiments.

FIG. 2 is a diagram illustrating a perspective view of another wireless consumer-electronic device, according to various embodiments.

FIG. 3 is a diagram showing a perspective view of a table having a base station incorporated therein, according to various embodiments.

FIG. 4 is a floorplan showing an example of a home in which a Wi-Fi network may be set up.

FIG. 5 shows the floorplan of FIG. 4 in which multiple moveable Wi-Fi devices are shown throughout the home, according to various embodiments.

FIG. 6 shows the floorplan of FIGS. 4 and 5 in which another set of multiple moveable Wi-Fi devices are arranged inside and outside of the home, according to various embodiments.

FIG. 7 is a diagram illustrating electrical circuitry disposed within an interior of a Wi-Fi pod, according to various embodiments.

FIG. 8 is a diagram illustrating electrical circuitry disposed within an interior of a docking station, according to various embodiments.

FIG. 9 is a network diagram of various Wi-Fi network topologies for connectivity to the Internet.

FIG. 10A is a network diagram of the Wi-Fi network with cloud-based control.

FIG. 10B is a network diagram of an example implementation of the Wi-Fi network, as a distributed Wi-Fi network in a tree topology.

FIG. 11A is a block diagram of functional components of the access points, mesh nodes, repeaters, etc., in the Wi-Fi networks of FIG. 9.

FIG. 11B is a logical diagram of the access points, mesh nodes, repeaters, etc. with a middleware layer to enable operation with the cloud service.

FIG. 12 is a block diagram of functional components of a server, a Wi-Fi client device, or a user device that may be used with the Wi-Fi network of FIG. 9 and/or the cloud-based control of FIG. 10A.

### DETAILED DESCRIPTION OF THE DISCLOSURE

The present disclosure relates to Wi-Fi systems and networks and more particularly related to the various Wi-Fi components or devices used for setting up a Wi-Fi system or network. As mentioned above, Wi-Fi devices are normally built with functionality in mind while design aesthetics might be a secondary concern. The present disclosure is directed to Wi-Fi device and/or other general consumer-electronic devices. If consumer-electronic devices are built with better aesthetics, design, form, etc. and are more pleasing to the eye, these device can be placed in more prominent spaces to reduce the amount of interference with respect to those pieces of electronic equipment that might normally be hidden away in a corner of the room, behind dressers, next to other high-power electronic devices, etc.

To render even more pleasing design aspects of electronic devices, the present disclosure further includes levitation systems, which allow relatively small consumer-electronic devices to float in the air. These devices can therefore be treated like a centerpiece device and might be a point of conservation for visitors. Not only does the levitating or floating feature give the electronic devices a more interesting and entertaining look, but it also allows the device to be positioned closer to where people might normally congregate. Specifically in the cases of electronic devices that include wireless communication capabilities, a center-positioned device can more easily provide wireless communication for users.

Therefore, the systems and methods of the present disclosure incorporate the levitation functionality into a decorative housing of an electronic device. In particular, some of the embodiments of the present disclosure are related to wireless consumer-electronic device and even more particularly related to Wi-Fi devices, such as Wi-Fi Access Point (AP) devices, Wi-Fi leaf devices, Wi-Fi pod devices, etc. Thus, normally dull-looking electronics can be designed with more creative forms such that they can instead be a centerpiece or showcase device with artistic and interesting designs.

### § 1.0 Levitating Wi-Fi Pod

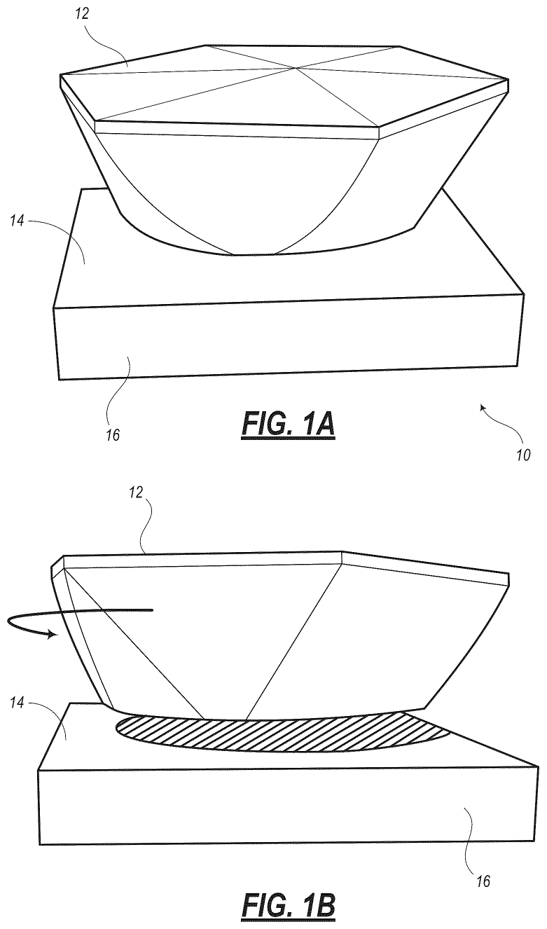

FIG. 1A is a diagram illustrating a perspective view of an embodiment of a levitating system 10. As illustrated, the levitating system 10 includes a wireless consumer-electronic device 12 sitting on a top surface 14 of a base station 16. The wireless consumer-electronic device 12 in this embodiment may be any type of Wi-Fi device (e.g., an AP device) that can be used within a Wi-Fi network. The wireless consumer-electronic device 12 includes an outer housing and electronics enclosed within the housing. The wireless consumer-electronic device 12 may be relatively small (e.g., about five or six inches in width) to allow it to easily levitate without consuming excessive amounts of power. In some embodiments, the housing may be configured where there are no ports on the surface thereof, thereby improving the aesthetics of the device. In addition to Wi-Fi devices, the wireless consumer-electronic devices may also include other types of electronic devices for performing any type of electrical functions and having a size and weight that may be capable of levitation above the base station 16.

FIG. 1B is a diagram illustrating a perspective view of the levitating system 10 of FIG. 1A where the wireless consumer-electronic device 12 is shown levitating and/or hovering above the surface 14 of the base station 16. Electrical circuitry, magnets, etc., may be used for creating electromagnetic fields for enabling the levitation action. The levitating circuitry described in the present disclosure may be configured to lift the wireless consumer-electronic device 12 off the top surface 14 of the base station 16 and cause the wireless consumer-electronic device 12 to hover in midair. Also, in some embodiments, the levitating circuitry may further include functionality to cause the wireless consumer-electronic device 12 to rotate about a vertical axis while hovering in midair. The rotation action may include spinning the wireless consumer-electronic device 12 in either a clockwise direction or counter-clockwise direction and may include spinning at any speed. Also, the rotation action of the levitating circuitry may enable the wireless consumer-electronic device 12 to rotate to a certain angle and then remain at that angle while hovering above the top surface 14 of the base station 16.

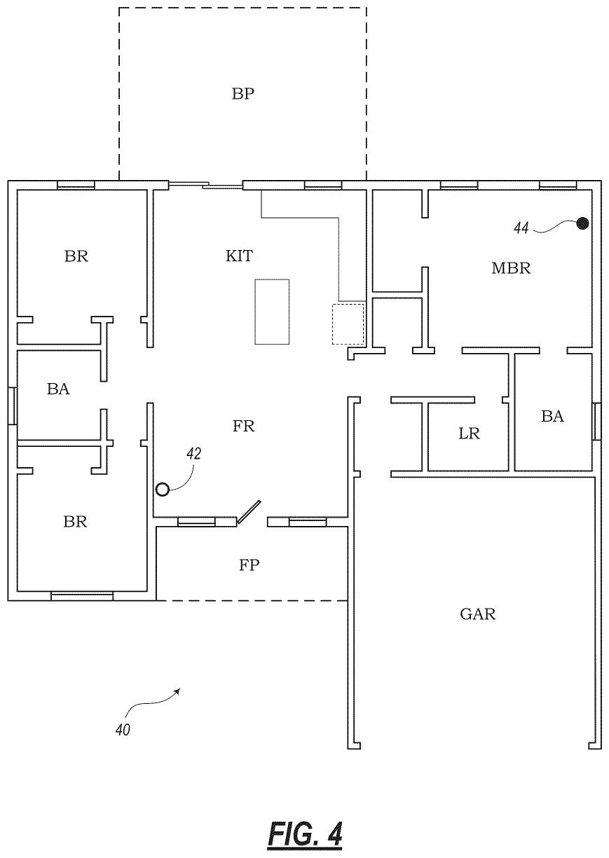

In some embodiments (see FIG. 3), circuitry for providing the levitation functionality may be incorporated solely within the wireless consumer-electronic device 12, which may then be capable of levitating above any surface. In other embodiments, circuitry for providing the levitation functionality may be incorporated solely within the base station 16, which may then be capable of levitating any type of wireless consumer-electronic device above its top surface 14. In still other embodiments, circuitry for providing the levitation functionality may be incorporated within both the wireless consumer-electronic device 12 and base station 16. When the levitation circuitry is split between the two components, one component, in some embodiments, may simply include a passive metallic or magnetic structure that may be configured to create react to electromagnetic fields created by the other component.

Furthermore, the wireless consumer-electronic device 12 may include a power source (e.g., one or more rechargeable batteries) that can be wirelessly charged by the base station 16. Thus, the base station 16 may include circuitry for wireless charging. The wireless consumer-electronic device 12 and base station 16 may include Near Field Communication (NFC) type of wireless charging systems for cooperatively recharging the batteries of the wireless consumer-electronic device 12 as needed. The base station 16 may therefore include a power cord (not shown) that can be plugged into an outlet for receiving power to achieve levitation functionality and batter recharging functionality.

### § 2.0 Self-Positioning Wi-Fi Pod

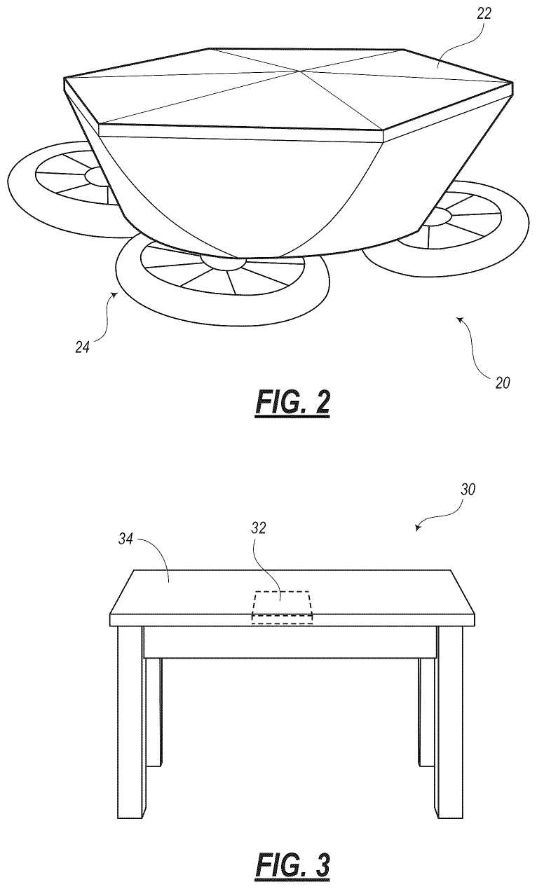

FIG. 2 is a diagram illustrating a perspective view of an embodiment of another wireless consumer-electronic device 20. As illustrated in this embodiment, the wireless consumer-electronic device 20 includes a housing 22 and a self-moving system 24. The housing 22 may include a non-conductive material and may be configured to enclose electronic circuitry (not shown in FIG. 2). The self-moving system 24 may include one or more propellers (e.g., quadcopter-type device or the like), which may be attached to the housing in any suitable manner. The self-moving system 24 may include similarities to drone-type devices that are capable of lifting into the air, rotating, moving in a substantial horizontal direction, etc. In some embodiments, the self-moving system 24 may include flight-pattern computing devices, sensors, etc. for assisting the wireless consumer-electronic device 20 to move itself from one position to another.

For example, in the case of use in a Wi-Fi network where the wireless consumer-electronic device 20 is a Wi-Fi AP device, the self-moving system 24 may receive information regarding Wi-Fi usage within a home and information regarding where the Wi-Fi AP device may be positioned for better Wi-Fi coverages for the users. In some cases, the self-moving system 24 may be configured to calculate the status of a Wi-Fi network by itself and calculate where the Wi-Fi AP device might be positioned. Furthermore, in a Wi-Fi system in which multiple Wi-Fi AP devices (e.g., wireless consumer-electronic devices 20) are deployed, the calculation of better positioning of Wi-Fi AP devices may include the calculation and movement of one or more of the Wi-Fi AP devices to provide better Wi-Fi coverage and improve signal strength to user devices.

The second embodiment of the wireless consumer-electronic device 20 may therefore enable movement from one area or room in a home to another. Also, since operating a device to achieve flight can consume a great amount of power, the wireless consumer-electronic device 20 may be incorporated in a system in which multiple charging stations having recharging capabilities can be spread throughout the home. The wireless consumer-electronic device 20 may be able to find these recharging stations and land there for recharging when the battery power is low. Again, both the wireless consumer-electronic device 20 and the recharging stations may have cooperating circuitry used for providing wireless (e.g., NFC) charging power to the wireless consumer-electronic device 20.

Therefore, according to various embodiments of the present disclosure, the wireless consumer-electronic device 12, 20 may include an outer housing and electronic circuitry arranged within the outer housing for performing one or more electronic functions. Also, the wireless consumer-electronic device 12, 20 may include a power source arranged within the outer housing, where the power source is configured to be charged wirelessly. The wireless consumer-electronic device 12, 20 may also include a movement action mechanism arranged within the outer housing. For example, the movement action mechanism may include the internal levitating features described with respect to FIG. 1 and/or the self-moving system or other suitable drone-type features described with respect to FIG. 2. That is, the movement action mechanism is configured to enable the wireless consumer-electronic device 12, 20 to at least perform the action of levitation. For example, the drone-type features can include rotors and the like to move, hover, etc. as well as navigation components.

In some embodiments, the electronic circuitry of the wireless consumer-electronic device may include Wi-Fi communication capabilities. The outer housing may include a common size and/or shape of a Wi-Fi device. For example, the wireless consumer-electronic device may be an Access Point (AP) device, a Wi-Fi pod device, a Wi-Fi leaf device, a Wi-Fi extender, or other suitable device that is configured to extend the range of Wi-Fi accessibility by communicating Wi-Fi signals intermediately between a user device and a Wi-Fi router over backhaul and fronthaul links.

The movement action mechanism described above may further be configured to enable the wireless consumer-electronic device 12, 20 to rotate while in a levitated position. The movement action mechanism is configured to operate in conjunction with a base station device (e.g., base station 16) for levitating and rotating the wireless consumer-electronic device 12, 20. The wireless consumer-electronic device 12, 20 may further include one or more antennas and one or more radios (e.g., Wi-Fi antennas and radios). The movement action mechanism and base station device may be configured to rotate the wireless consumer-electronic device 12, 20 in order to strategically steer the one or more antennas for increasing the strength of wireless communication signals, for increasing wireless coverage, and/or for reducing signal interference.

The power source of the wireless consumer-electronic device 12, 20 may include a rechargeable battery unit and may be configured to operate in conjunction with the base station device for charging the rechargeable battery unit. The power source and base station device, for example, may utilize magnetic induction for charging the rechargeable battery unit.

According to some embodiment (e.g., particularly with respect to FIG. 2), the movement action mechanism of the wireless consumer-electronic device 20 may be configured to move the wireless consumer-electronic device 20 in vertical and horizontal directions to enable self-positioning of the wireless consumer-electronic device 20 within an area. The electronic circuitry of the wireless consumer-electronic device 20 may include wireless communication capabilities, wherein the movement action mechanism may be configured to move the wireless consumer-electronic device 20 to a location and/or orientation for increasing the strength or coverage of wireless communication signals and/or for reducing wireless communication interference. The wireless consumer-electronic device 20 may further include one or more sensors for sensing obstacles while the movement action mechanism is moving the wireless consumer-electronic device 20, whereby the electronic circuitry may further include navigation functionality to help the movement action mechanism avoid the sensed obstacles. The action of self-positioning the wireless consumer-electronic device 20 may include landing the wireless consumer-electronic device 20 on a base station device selected from one or more base station devices within a certain area to enable the power source to be wirelessly recharged.

Furthermore, according to various embodiments, the wireless consumer-electronic device 12, 20 may also include a speaker driver arranged within the outer housing (e.g., housing 22). When the wireless consumer-electronic device 12, 20 is positioned on an external object having a flat surface, such as a table, desk, countertop, chair, floor, etc. In particular, the speaker driver may be configured to vibrate the external object in order to generate sound, thereby treating the external object as a speaker membrane that can create sound when vibrated.

Additionally, the electronic circuitry of the wireless consumer-electronic device 12, 20 may also include a microphone and smart assistance circuitry. For example, the smart assistance circuitry may be configured to receive spoken instructions from a nearby user in order to cause the electronic circuitry to automatically perform one or more actions. For example, the smart assistance circuitry, in response to receiving instructions, may be configured to place a phone call, access the Internet, monitor a security system, monitor one or more Internet of Things (IOT) devices, control the lights, control the volume of a speaker system, or other types of actions.

It may further be noted that the wireless consumer-electronic device 12, 20 may be configured such that the outer housing (e.g., housing 22) is devoid of electrical ports. That is, wireless electronic functions can be performed without wires and even the power charging can be performed wirelessly. Also, in other embodiments, the wireless consumer-electronic device 12, 20 may further include one or more audio and/or visual output devices configured to indicate when a power level of the power source is low, when the strength of a wireless link is low, when an Internet connection is down, and/or other indications of other monitored conditions.

§ 3.0 Docking Station Incorporated into Furniture

FIG. 3 is a diagram showing a perspective view of an embodiment of a table 30 having a base station 32 (shown in phantom) incorporated therein. For example, the base station 32 may be positioned out-of-sight, such as under a top surface 34 of the table. It should be noted that the table 30 may be any type of table (e.g., kitchen table, coffee table, bed-side table, work table, etc.) or instead may be any type of furniture (e.g., desk, chair, stool, shelving unit, coat rack, etc.) or built-in structural feature of a home or office having a horizontal surface (e.g., countertop, half wall, step, stair, landing, floor, etc.). The base station 32 may include levitating and/or wireless charging capabilities for operating with the wireless consumer-electronic device 12, 20. In some embodiments, the location of the base station 32 may be detectable in any suitable manner to allow the wireless consumer-electronic device 12, 20 to land on the top surface 34 of the table 30 above the base station 32 to enable the levitating and/or charging features.

§ 4.0 Systems with Multiple Levitating or Self-Moving Wi-Fi Pods

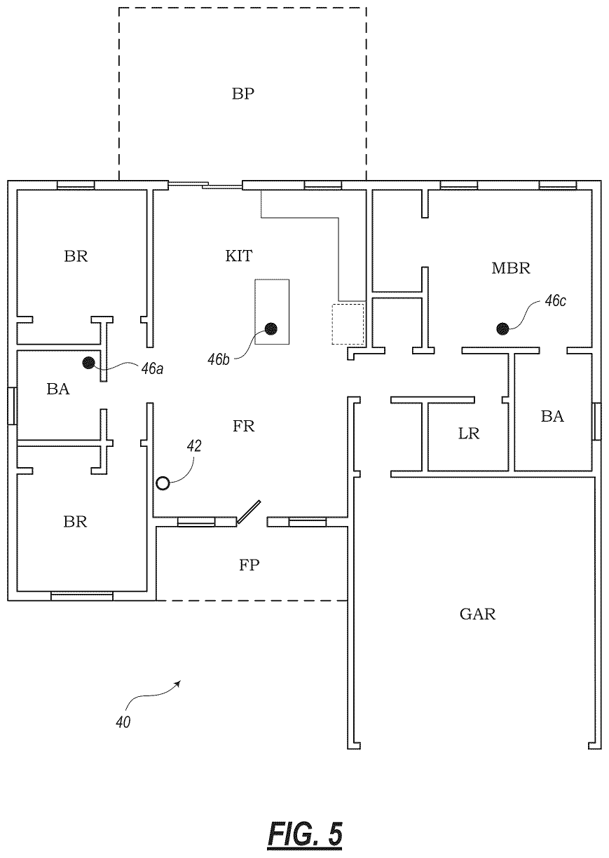

FIG. 4 is a floorplan 40 showing an example of a home in which a Wi-Fi network may be set up. Although a specific floorplan is shown in this example, it should be noted that the present disclosure is not limited by the type of structure (e.g., home, office suite, work area, conference room, library, restaurant, etc.), the type of floorplan or layout of walls, the number of floors of the building, etc. Nevertheless, for the purpose of illustration, the floorplan 40 in this example includes multiple bedrooms, multiple bathrooms, a kitchen, a family room, a laundry room, a garage, a front patio, and a back patio. These rooms and areas may be separated from each other by multiple walls and doors (not shown). In this example, two Wi-Fi devices are used for enabling proper Wi-Fi accessibility by user devices within the home. A first Wi-Fi device 42 is a Wi-Fi router, modem, gateway device, etc. used for connecting the Wi-Fi network to the Internet. The first Wi-Fi device may be plugged in to a wall outlet for receiving power and may also be connected via Ethernet cables to a service provider network.

A second Wi-Fi device 44 is placed in the master bedroom in this example. The second Wi-Fi device 44 may be plugged into a wall outlet (e.g., near to a bed) for providing strong Wi-Fi signal to users in the master bedroom. The second Wi-Fi device 44 may include wireless capabilities configured to communicate with the first Wi-Fi device 42 to form a backhaul link. In this way, the second Wi-Fi device 44 can extend the reach of the Wi-Fi network within the home.

It may be noted that this arrangement of FIG. 4 may represent a typical arrangement in which the Wi-Fi devices 42, 44 are positioned out of the way, such as behind or under furniture, sitting on the floor behind a chair, sitting on a bed-side table, etc. Thus, in this arrangement, the Wi-Fi device 42, 44 may experience a great amount of interference from the walls, furniture, other electronic devices, etc., which can degrade the quality of the Wi-Fi signals and user experience.

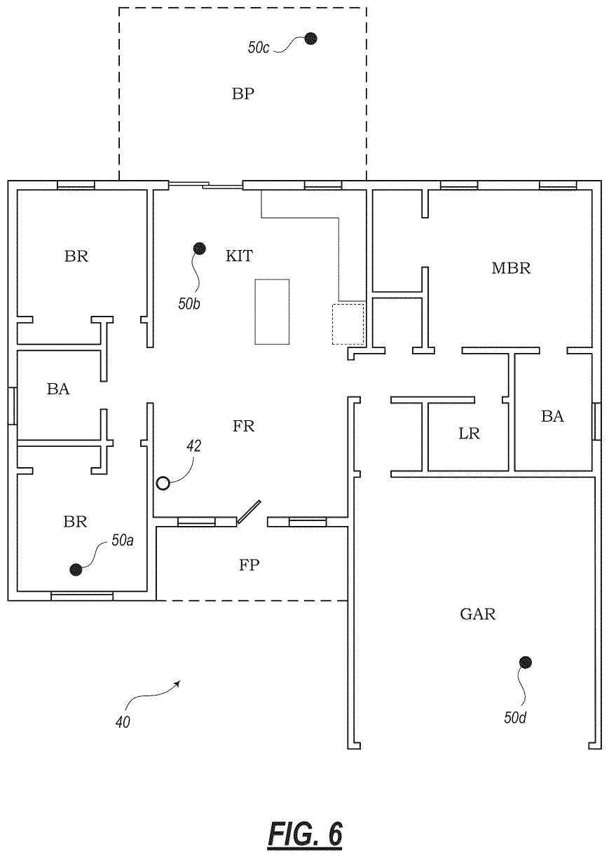

FIG. 5 shows the same floorplan 40 as shown in FIG. 4. The first Wi-Fi device 42, which is wired, remains in the same position as before. However, in this example, multiple moveable Wi-Fi devices 46 are shown throughout the home. A first moveable Wi-Fi device 46a is shown in a shared bathroom, for example, and may be placed in a prominent spot (e.g., on a bathroom countertop or vanity). The first moveable Wi-Fi device 46a may be used for providing service to the two nearby bedrooms. A second moveable Wi-Fi device 46b is shown in the kitchen, for example, and may also be placed in a prominent spot (e.g., on a countertop or island). The second moveable Wi-Fi device 46b may be used for providing service to the kitchen, family room, and back patio. A third moveable Wi-Fi device 46c is shown in the master bedroom, for example, and may also be placed in a prominent spot (e.g., on top of a dresser). The third moveable Wi-Fi device 46c may be used for providing service to the master bedroom, master bathroom, laundry room, and garage.

With the Wi-Fi devices 46 positioned in prominent spots, they may include better-looking equipment, which may be wireless (i.e., no ugly wires), may have a pleasing appearance, and may have an interesting or appealing quality (e.g., the ability to levitate and rotate in midair). Thus, the wireless consumer-electronic devices 12, 20 described above with respect to FIGS. 1 and 2 may be used as the moveable Wi-Fi device 46 shown in FIG. 5. Also, appropriate base station devices (e.g., base station 16, 32, etc.) may be incorporated into the system to enable levitation (if needed) and/or power charting functionality.

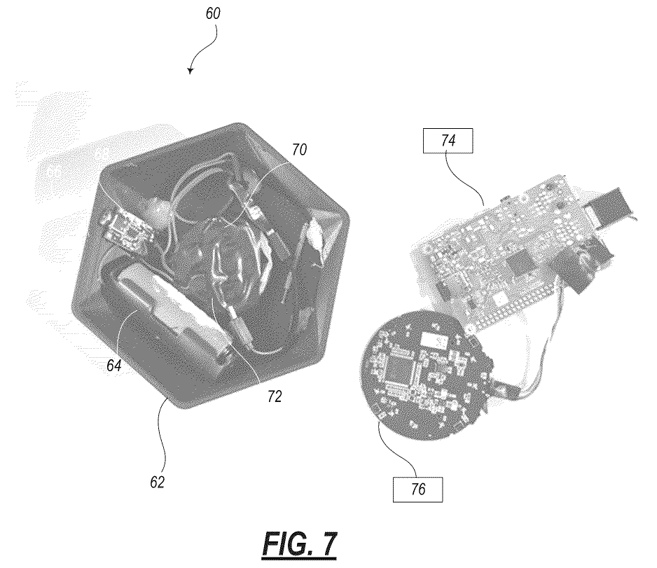

FIG. 6 shows the same floorplan 40 as shown in FIGS. 4 and 5. Again, the first Wi-Fi device 42, which is wired, may remain in the same spot. However, in this example, another set of multiple moveable Wi-Fi devices 50 may be arranged throughout the home and may even be arranged beyond the exterior walls of the home. This arrangement may be based on a detected need, such as the location of people in the home or on the premises, the user devices being used with the Wi-Fi network, the type and demand of the user devices, etc. In response to the particular need at any given time, the moveable Wi-Fi devices 50 may be positioned as needed. The moveable Wi-Fi devices 50 may include one or more devices configured as the wireless consumer-electronic devices 12 shown in FIG. 1 and may be manually moved (with their respective base stations 16) to desired locations (as shown in FIG. 6). Also, the moveable Wi-Fi devices 50 may include one or more devices configured as the wireless consumer-electronic devices 20 shown in FIG. 2 and may be navigated automatically to the desired locations (as shown in FIG. 6), which may, in some embodiments, correspond to the known locations of base stations (for recharging as needed) or may be independent of base station locations.

In the example of FIG. 6, suppose the residents of the home are throwing a party. Also, suppose that a group of teenagers is hanging out in a bedroom playing video games and chatting online. In this case, a first moveable Wi-Fi device 50a may be moved (manually or automatically) to a desk or table in that bedroom. Also, suppose that a second group of people is hanging out at a kitchen table, where some people are texting and others are watching videos online. In this case, a second moveable Wi-Fi device 50b may be moved (manually or automatically) to the center of the kitchen table. Also, suppose that a third group of people is hanging out on the back patio, where some people are checking the weather forecast online and some people are looking at online videos about how to start a fire by rubbing two sticks together. In this case, a third moveable Wi-Fi device 50c may be moved (manually or automatically) to an outdoor table on the back patio. Also, suppose that fourth group of people is hanging out in the garage, where some people are searching online for famous garage bands. In this case, a fourth moveable Wi-Fi device 50d may be moved (manually or automatically) to a spot in the garage. It should be noted that these example are merely provided for illustration purposes only and are not meant to be limiting.

In order to facility the automatic movement of the wireless consumer-electronic device 20 from one room to another, the wireless consumer-electronic device 20 may be equipped with one or more sensors for navigating hallways, doorways, etc. In some cases, there may be obstacles to this movement, such as, for example, if a door or window is closed or if a person or other object is blocking the path. The wireless consumer-electronic device 20 may include a beeper, buzzer, speaker, or other audio output device and/or a light, LED, or other visual output device for providing a suitable type of alert to get the attention of a nearby person to help clear the path (e.g., open a door or window).

Therefore, according to various embodiments of the present disclosure, a system for optimizing (or improving) the range, accessibility, signal strength, Signal to Noise Ratio (SNR), etc. is described herein. The system may include one or more base station devices (e.g., base stations 16, 32) and one or more wireless consumer-electronic devices 12, 20, 46, 50. Each wireless consumer-electronic device may include an outer housing (e.g., housing 22) and electronic circuitry arranged within the outer housing for performing one or more electronic functions. Each wireless consumer-electronic device 12, 20, 46, 50 may also include a power source arranged within the outer housing, where the power source may be configured to be charged wirelessly by a nearby base station device of the one or more base station devices. Also, each wireless consumer-electronic device 12, 20, 46, 50 may include a movement action mechanism arranged within the outer housing. The movement action mechanism and a nearby base station device may be configured to enable the wireless consumer-electronic device 12 to levitate (and rotate). Alternatively, the movement action mechanism may be configured to enable levitation without the need for a base station device. In this respect, the wireless consumer-electronic device 20 may be configured to levitate, rotate, move horizontally, and land.

This system may further include a Wi-Fi router (e.g., first Wi-Fi device 42) that is configured to establish a Wi-Fi network. The one or more wireless consumer-electronic devices 12, 20, 46, 50 may include a plurality of Wi-Fi Access Point (AP) devices. The Wi-Fi router 42 may be configured to determine the status of the Wi-Fi network to calculate desired locations of the Wi-Fi AP devices 12, 20, 46, 50 to increase Wi-Fi signal strength and/or reduce Wi-Fi signal interference. The movement action mechanism of each Wi-Fi AP device 20 may be configured to automatically position the respective Wi-Fi AP device to one of the calculated locations for better user quality experiences. One or more of the Wi-Fi AP devices 46, 50 may act as an intermediate device between the Wi-Fi router 42 and one or more other Wi-Fi AP devices 46, 50 to extend the reach of the Wi-Fi network.

In addition, each base station device may include one or more magnets and/or electromagnets for enabling a nearby wireless consumer-electronic device 12 to levitate. Each base station device may also include one or more charging coils for wirelessly charging the nearby wireless consumer-electronic device 12 and a magnetic gear device configured to rotate the nearby wireless consumer-electronic device 12 to a predetermined rotational orientation. The nearby wireless consumer-electronic device 12 in this embodiment may include a directional Wi-Fi antenna, wherein the predetermined rotational orientation is based on steering the directional Wi-Fi antenna in a direction to increase Wi-Fi signal strength and/or reduce Wi-Fi signal interference.

One or more of the base station devices 16, 32 may be is incorporated in a table 30, desk, or countertop, etc. A respective wireless consumer-electronic device 12, 20, 46, 50 may be configured to levitate above a top surface 34 of the table 30, desk, or countertop. The movement action mechanism of each wireless consumer-electronic device 12, 20, 46, 50 may further be configured to enable the respective wireless consumer-electronic device 12, 20, 46, 50 to rotate while in a levitated position. In some embodiments, the movement action mechanism of each wireless consumer-electronic device 12, 20, 46, 50 may be configured to operate in conjunction with a corresponding base station device for levitating and rotating the respective wireless consumer-electronic device 12, 20, 46, 50. Each wireless consumer-electronic device 12, 20, 46, 50 may further include one or more antennas and one or more radios, wherein the respective movement action mechanism (and corresponding base station device, when applicable) are configured to rotate the respective wireless consumer-electronic device 12, 20, 46, 50 in order to strategically steer the one or more antennas for increasing the strength of wireless communication signals, for increasing wireless coverage, and/or for reducing signal interference.

### § 5.0 Circuitry of Wi-Fi Pods

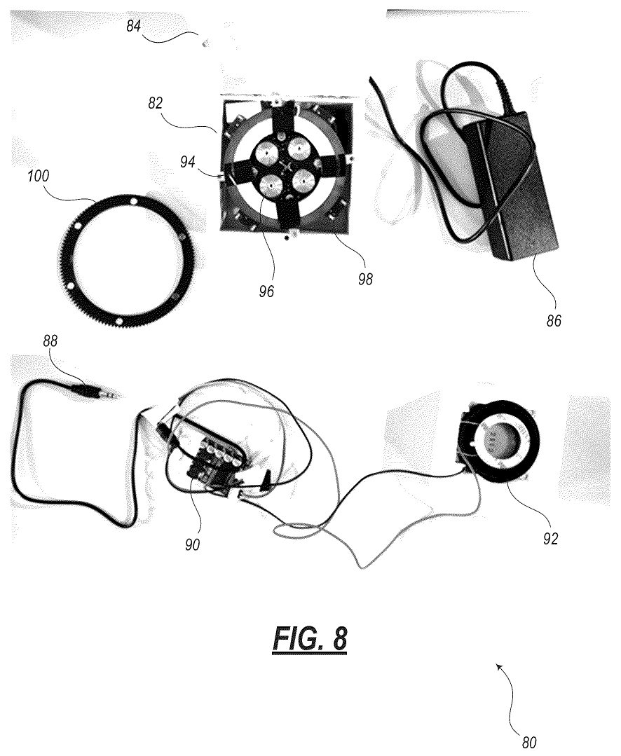

FIG. 7 is a diagram illustrating an embodiment of electrical circuitry disposed within the interior of a Wi-Fi pod 60 (e.g., the wireless consumer-electronic device 12, 20, a Wi-Fi AP device, a Wi-Fi leaf device, etc.). In this embodiment, the Wi-Fi pod 60 includes a housing 62 (similar to housing 22), one or more rechargeable batteries 64, a charging module 66, a magnet 68 (for movement), a power converter 70, and a levitating and charging module 72. The levitating and charging module 72 may be configured with a magnet platform for levitation and a charging coil for charging the one or more rechargeable batteries 64. Also, the electrical circuitry of the Wi-Fi pod 60 may also include one or more printed circuit boards. A first circuit board 74 may include components for wireless communication (e.g., Wi-Fi communications). The first circuit board 74 may also include sensors (e.g., proximity sensors, navigation sensors, wireless signal detection, cameras, etc.). In this embodiment, a second circuit board 76 may include a microphone and speaker assembly.

### § 6.0 Circuitry of Docking Stations

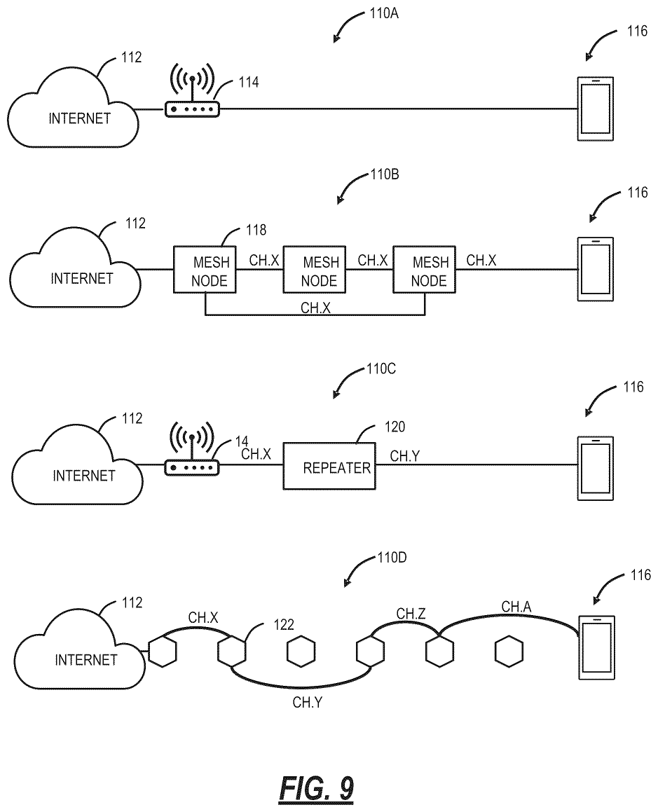

FIG. 8 is a diagram illustrating an embodiment of electrical circuitry disposed within the interior of a docking station 80 (e.g., base station 16, 32). In this embodiment, the docking station 80 includes a housing 82 and a cover 84. The docking station 80 also includes a power supply 86, a jack connector 88 (e.g., for connection with Bluetooth audio modules), an amplifier 90, and a speaker driver device 92 (or exciter). Internal electrical circuitry of the docking station 80 also includes a large magnet and one or more electromagnets forming a levitating platform 94, a charging coil 96, calibration LEDs 98, and a magnetic gear device 100. In some embodiments, the docking station 80 may include four electromagnets 94 (as shown). The magnetic gear device 100 is configured to change the magnetic fields to control rotation of the wireless consumer-electronic device 12, 20 to steer or orient it to a specific rotational angle. The docking station 80 may be configured as a charging port for charging the Wi-Fi pod 60 and can also be part of the first Wi-Fi device 42 shown in FIGS. 4-6 or other router, modem, gateway, etc. In other embodiment, the docking station 80 may simply be used for charging and levitating purposes.

The levitating pod (e.g., wireless consumer-electronic device 12, 20, 46, 50, Wi-Fi pod 60, etc.) described in the present disclosure may be configured to operate using open source modules, such as OpenSync. To enable free movement, the levitating pod is not tethered to any electrical wires. As such, the housing of the levitating pod does not include any electrical ports, USB ports, micro-USB ports, USB-C ports, headphone jack ports, cable connectors, etc. Instead, the levitating pod can be charged wirelessly when position on top of or hovering over a docking station. The levitating pod may be configured to use Wi-Fi, 5G wireless, Bluetooth, NFC, and other types of wireless communication and/or wireless IP connections.

The levitating pod may be part of a system that includes real-time optimization of Wi-Fi network accessibility areas. The pods may include Wi-Fi antennas and radios and may be moved within a space or area (e.g., within a home or office building) to get the best coverage based on where people are, what user devices they are using, how much data traffic is transmitted and/or received throughout the area, any interference (e.g., channel interference from other devices in the residence or from neighbors), the location of other sources of noise interference (e.g., from refrigerators, kitchen appliances, HVAC systems, TVs, computers, etc.). Thus, the system can determine the best locations for each pod in the system and instruct people to move the levitating pods manually or allow the self-moving pods (e.g., wireless consumer-electronic device 20) to repositioned themselves as needed to optimize (or improve) coverage and reduce interference.

Also, in some embodiments, the levitating pod can be integrated with many other types of devices throughout the home, such as a mobile phone, a doorbell apparatus, a security system, IoT devices, smart assistance devices, etc. In some implementations, the levitating pods may allow a user to speak instructions and allow the levitating pod control certain electronic systems.

### § 6.1 Docketing Station on the Ceiling

The base station 16 in FIGS. 1A and 1B is shown where the wireless consumer-electronic device 12 sits on top of the base station 16. Here, the levitation base station is based on electromagnets that push the wireless consumer-electronic device 12. In some scenarios, it might not be feasible or practical to land the wireless consumer-electronic device 12 due to obstacles. In another embodiment, the base station 16 and the wireless consumer-electronic device 12 can use the opposite direction with the magnets.

The base station 16 can be located on a ceiling that pulls the wireless consumer-electronic device 12 to a fixed hovering position and charges it (during that time the wireless consumer-electronic device 12 should be able to shut down propellers). description for movement and rotations remains the same. Usually on the ceiling there are less obstacles than on the floor, table, countertop etc.

Now, for safety, when the is a power outage, which could lead to the wireless consumer-electronic device 12 failing from the ceiling. Here, we could just do a magnet based static line/rope.

### § 7.0 Wi-Fi Network Topologies

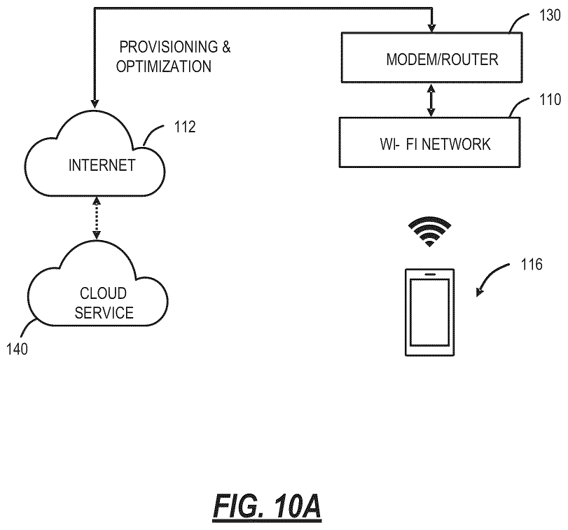

FIG. 9 is a network diagram of various Wi-Fi network 110 (namely Wi-Fi networks 110A—110D) topologies for connectivity to the Internet 112. The Wi-Fi network 110 can operate in accordance with the IEEE 802.11 protocols and variations thereof. The Wi-Fi network 110 is deployed to provide coverage in a physical location, e.g., home, business, store, library, school, park, etc. The differences in the topologies of the Wi-Fi networks 110 are that they provide different scope of physical coverage. As described herein and as known in the art, the Wi-Fi network 110 can be referred to as a network, a system, a Wi-Fi network, a Wi-Fi system, a cloud-based Wi-Fi system, etc. The access points 114 and equivalent (i.e., mesh nodes 118, repeater 120, and devices 122) can be referred to as nodes, access points, Wi-Fi nodes, Wi-Fi access points, etc. The objective of the nodes is to provide network connectivity to Wi-Fi client devices 116 which can be referred to as client devices, user equipment, user devices, clients, Wi-Fi clients, Wi-Fi devices, etc. Note, those skilled in the art will recognize the Wi-Fi client devices 116 can be mobile devices, tablets, computers, consumer electronics, home entertainment devices, televisions, Internet of Things (IOT) devices, or any network-enabled device.

The Wi-Fi network 110A includes a single access point 114, which can be a single, high-powered access point 114, which may be centrally located to serve all Wi-Fi client devices 116 in a location. Of course, a typical location can have several walls, floors, etc. between the single access point 114 and the Wi-Fi client devices 116. Plus, the single access point 114 operates on a single channel (or possible multiple channels with multiple radios), leading to potential interference from neighboring systems. The Wi-Fi network 110B is a Wi-Fi mesh network that solves some of the issues with the single access point 114 by having multiple mesh nodes 118, which distribute the Wi-Fi coverage. Specifically, the Wi-Fi network 110B operates based on the mesh nodes 118 being fully interconnected with one another, sharing a channel such as a channel X between each of the mesh nodes 118 and the Wi-Fi client device 116. That is, the Wi-Fi network 110B is a fully interconnected grid, sharing the same channel, and allowing multiple different paths between the mesh nodes 118 and the Wi-Fi client device 116. However, since the Wi-Fi network 110B uses the same backhaul channel, every hop between source points divides the network capacity by the number of hops taken to deliver the data. For example, if it takes three hops to stream a video to a Wi-Fi client device 116, the Wi-Fi network 110B is left with only ⅓ the capacity.

The Wi-Fi network 110C includes the access point 114 coupled wirelessly to a Wi-Fi repeater 120. The Wi-Fi network 110C with the repeaters 120 is a star topology where there is at most one Wi-Fi repeater 120 between the access point 114 and the Wi-Fi client device 116. From a channel perspective, the access point 114 can communicate to the Wi-Fi repeater 120 on a first channel, Ch. X, and the Wi-Fi repeater 120 can communicate to the Wi-Fi client device 116 on a second channel, Ch. Y. The Wi-Fi network 110C solves the problem with the Wi-Fi mesh network of requiring the same channel for all connections by using a different channel or band for the various hops (note, some hops may use the same channel/band, but it is not required), to prevent slowing down the Wi-Fi speed. One disadvantage of the repeater 120 is that it may have a different service set identifier (SSID), from the access point 114, i.e., effectively different Wi-Fi networks from the perspective of the Wi-Fi client devices 116.

Despite Wi-Fi's popularity and ubiquity, many consumers still experience difficulties with Wi-Fi. The challenges of supplying real-time media applications, like those listed above, put increasing demands on the throughput, latency, jitter, and robustness of Wi-Fi. Studies have shown that broadband access to the Internet through service providers is up 99.9% of the time at high data rates. However, despite the Internet arriving reliably and fast to the edge of consumer's homes, simply distributing the connection across the home via Wi-Fi is much less reliable leading to poor user experience.

Several issues prevent conventional Wi-Fi systems from performing well, including i) interference, ii) congestion, and iii) coverage. For interference, with the growth of Wi-Fi has come the growth of interference between different Wi-Fi networks which overlap. When two networks within range of each other carry high levels of traffic, they interfere with each other, reducing the throughput that either network can achieve. For congestion, within a single Wi-Fi network, there may be several communications sessions running. When several demanding applications are running, such as high-definition video streams, the network can become saturated, leaving insufficient capacity to support the video streams.

For coverage, Wi-Fi signals attenuate with distance and when traveling through walls and other objects. In many environments, such as residences, reliable Wi-Fi service cannot be obtained in all rooms. Even if a basic connection can be obtained in all rooms, many of those locations will have poor performance due to a weak Wi-Fi signal. Various objects in a residence such as walls, doors, mirrors, people, and general clutter all interfere and attenuate Wi-Fi signals leading to slower data rates.

Two general approaches have been tried to improve the performance of conventional Wi-Fi systems, as illustrated in the Wi-Fi networks 110A, 110B, 110C. The first approach (the Wi-Fi network 110A) is to simply build more powerful single access points, in an attempt to cover a location with stronger signal strengths, thereby providing more complete coverage and higher data rates at a given location. However, this approach is limited by both regulatory limits on the allowed transmit power, and by the fundamental laws of nature. The difficulty of making such a powerful access point, whether by increasing the power, or increasing the number of transmit and receive antennas, grows exponentially with the achieved improvement. Practical improvements using these techniques lie in the range of 6 to 12 dB. However, a single additional wall can attenuate by 12 dB. Therefore, despite the huge difficulty and expense to gain 12 dB of the link budget, the resulting system may not be able to transmit through even one additional wall. Any coverage holes that may have existed will still be present, devices that suffer poor throughput will still achieve relatively poor throughput, and the overall system capacity will be only modestly improved. In addition, this approach does nothing to improve the situation with interference and congestion. In fact, by increasing the transmit power, the amount of interference between networks actually goes up.

A second approach is to use repeaters or a mesh of Wi-Fi devices to repeat the Wi-Fi data throughout a location, as illustrated in the Wi-Fi networks 110B, 110C. This approach is a fundamentally better approach to achieving better coverage. By placing even a single repeater 120 in the center of a house, the distance that a single Wi-Fi transmission must traverse can be cut in half, halving also the number of walls that each hop of the Wi-Fi signal must traverse. This can make a change in the link budget of 40 dB or more, a huge change compared to the 6 to 12 dB type improvements that can be obtained by enhancing a single access point as described above. Mesh networks have similar properties as systems using Wi-Fi repeaters 120. A fully interconnected mesh adds the ability for all the mesh nodes 118 to be able to communicate with each other, opening the possibility of packets being delivered via multiple hops following an arbitrary pathway through the network.

The Wi-Fi network 110D includes various Wi-Fi devices 122 that can be interconnected to one another wirelessly (Wi-Fi wireless backhaul links) or wired, in a tree topology where there is one path between the Wi-Fi client device 116 and the gateway (the Wi-Fi device 122 connected to the Internet), but which allows for multiple wireless hops unlike the Wi-Fi repeater network and multiple channels unlike the Wi-Fi mesh network. For example, the Wi-Fi network 110D can use different channels/bands between Wi-Fi devices 122 and between the Wi-Fi client device 116 (e.g., Ch. X, Y, Z, A), and, also, the Wi-Fi system 110 does not necessarily use every Wi-Fi device 122, based on configuration and optimization. The Wi-Fi network 110D is not constrained to a star topology as in the Wi-Fi repeater network which at most allows two wireless hops between the Wi-Fi client device 116 and a gateway. Wi-Fi is a shared, simplex protocol meaning only one conversation between two devices can occur in the network at any given time, and if one device is talking the others need to be listening. By using different Wi-Fi channels, multiple simultaneous conversations can happen simultaneously in the Wi-Fi network 110D. By selecting different Wi-Fi channels between the Wi-Fi devices 122, interference and congestion can be avoided or minimized.

Of note, the systems and methods described herein contemplate operation through any of the Wi-Fi networks 110, including other topologies not explicated described herein. Also, if there are certain aspects of the systems and methods which require multiple nodes in the Wi-Fi network 110, this would exclude the Wi-Fi network 110A.

### § 7.1 Cloud-Based Control

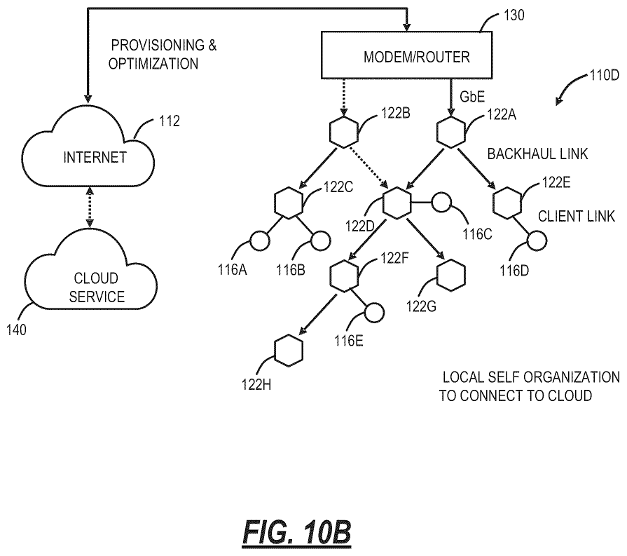

FIG. 10A is a network diagram of the Wi-Fi network 110 with cloud-based control. The Wi-Fi network 110 includes a gateway device which is any of the access points 114, the mesh node 118, or the Wi-Fi device 122 that connects to a modem/router 130 that is connected to the Internet 112. For external network connectivity, the modem/router 130 which can be a cable modem, Digital Subscriber Loop (DSL) modem, cellular interface, or any device providing external network connectivity to the physical location associated with the Wi-Fi network 110. In an embodiment, the Wi-Fi network 110 can include centralized control such as via a cloud service 140 located on the Internet 112 and configured to control multiple Wi-Fi networks 110. The cloud service 140 can receive measurement data, analyze the measurement data, and configure the nodes in the Wi-Fi network 110 based thereon. This cloud-based control is contrasted with a conventional operation that relies on a local configuration such as by logging in locally to an access point.

Of note, cloud-based control can be implemented with any of the Wi-Fi networks 110, with monitoring through the cloud service 140. For example, different vendors can make access points 114, mesh nodes 118, repeaters 120, Wi-Fi devices 122, etc. However, it is possible for unified control via the cloud using standardized techniques for communication with the cloud service 140. One such example includes OpenSync, sponsored by the Applicant of the present disclosure and described at www.opensync.io/documentation. OpenSync is cloud-agnostic open-source software for the delivery, curation, and management of services for the modern home. That is, this provides standardization of the communication between devices and the cloud service 140. OpenSync acts as silicon, Customer Premises Equipment (CPE), and cloud-agnostic connection between the in-home hardware devices and the cloud service 140. This is used to collect measurements and statistics from the connected Wi-Fi client devices 116 and network management elements, and to enable customized connectivity services.

As described herein, cloud-based management includes reporting of Wi-Fi related performance metrics to the cloud service 140 as well as receiving Wi-Fi-related configuration parameters from the cloud service 140. The systems and methods contemplate use with any Wi-Fi network 110. The cloud service 140 utilizes cloud computing systems and methods to abstract away physical servers, storage, networking, etc. and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client's web browser or the like, with no installed client version of an application required. Centralization gives cloud service providers complete control over the versions of the browser-based and other applications provided to clients, which removes the need for version upgrades or license management on individual client computing devices. The phrase SaaS is sometimes used to describe application programs offered through cloud computing. A common shorthand for a provided cloud computing service (or even an aggregation of all existing cloud services) is “the cloud.”

### § 7.2 Distributed Wi-Fi Network

FIG. 10B is a network diagram of an example implementation the Wi-Fi network 110D, as a distributed Wi-Fi network in a tree topology. The distributed Wi-Fi network 110D includes a plurality of access points 122 (labeled as access points 122A—122H) which can be distributed throughout a location, such as a residence, office, or the like. That is, the distributed Wi-Fi network 110D contemplates operation in any physical location where it is inefficient or impractical to service with a single access point, repeaters, or a mesh system. In a typical deployment, the distributed Wi-Fi network 110D can include between 1 to 12 access points or more in a home. A large number of access points 122 (which can also be referred to as nodes in the distributed Wi-Fi system 110) ensures that the distance between any access point 122 is always small, as is the distance to any Wi-Fi client device 116 needing Wi-Fi service. That is, an objective of the distributed Wi-Fi network 110D is for distances between the access points 122 to be of similar size as distances between the Wi-Fi client devices 116 and the associated access point 122. Such small distances ensure that every corner of a consumer's home is well covered by Wi-Fi signals. It also ensures that any given hop in the distributed Wi-Fi network 110D is short and goes through few walls. This results in very strong signal strengths for each hop in the distributed Wi-Fi network 110D, allowing the use of high data rates, and providing robust operation.

For external network connectivity, one or more of the access points 114 can be connected to a modem/router 130 which can be a cable modem, Digital Subscriber Loop (DSL) modem, or any device providing external network connectivity to the physical location associated with the distributed Wi-Fi network 110D.

While providing excellent coverage, a large number of access points 122 (nodes) presents a coordination problem. Getting all the access points 122 configured correctly and communicating efficiently requires centralized control. This control is preferably done via the cloud service 140 that can be reached across the Internet 112 and accessed remotely such as through an application (“app”) running on a client device 116. That is, in an exemplary aspect, the distributed Wi-Fi network 110D includes cloud-based control (with a cloud-based controller or cloud service) to optimize, configure, and monitor the operation of the access points 122 and the Wi-Fi client devices 116. This cloud-based control is contrasted with a conventional operation which relies on a local configuration such as by logging in locally to an access point. In the distributed Wi-Fi network 110D, the control and optimization does not require local login to the access point 122, but rather the Wi-Fi client device 116 communicating with the cloud service 4, such as via a disparate network (a different network than the distributed Wi-Fi network 110D) (e.g., LTE, another Wi-Fi network, etc.).

The access points 122 can include both wireless links and wired links for connectivity. In the example of FIG. 10B, the access point 122A has an exemplary gigabit Ethernet (GbE) wired connection to the modem/router 130. Optionally, the access point 122B also has a wired connection to the modem/router 130, such as for redundancy or load balancing. Also, the access points 122A, 22B can have a wireless connection to the modem/router 130. Additionally, the access points 122A, 22B can have a wireless gateway such as to a cellular provider as is described in detail herein. The access points 122 can have wireless links for client connectivity (referred to as a client link) and for backhaul (referred to as a backhaul link). The distributed Wi-Fi network 110D differs from a conventional Wi-Fi mesh network in that the client links and the backhaul links do not necessarily share the same Wi-Fi channel, thereby reducing interference. That is, the access points 122 can support at least two Wi-Fi wireless channels—which can be used flexibly to serve either the client link or the backhaul link and may have at least one wired port for connectivity to the modem/router 130, or for connection to other devices. In the distributed Wi-Fi network 110D, only a small subset of the access points 122 require direct connectivity to the modem/router 130 with the non-connected access points 122 communicating with the modem/router 130 through the backhaul links back to the connected access points 122A, 122B. Of course, the backhaul links may also be wired Ethernet connections, such as in a location have a wired infrastructure.

### § 8.0 Access Point

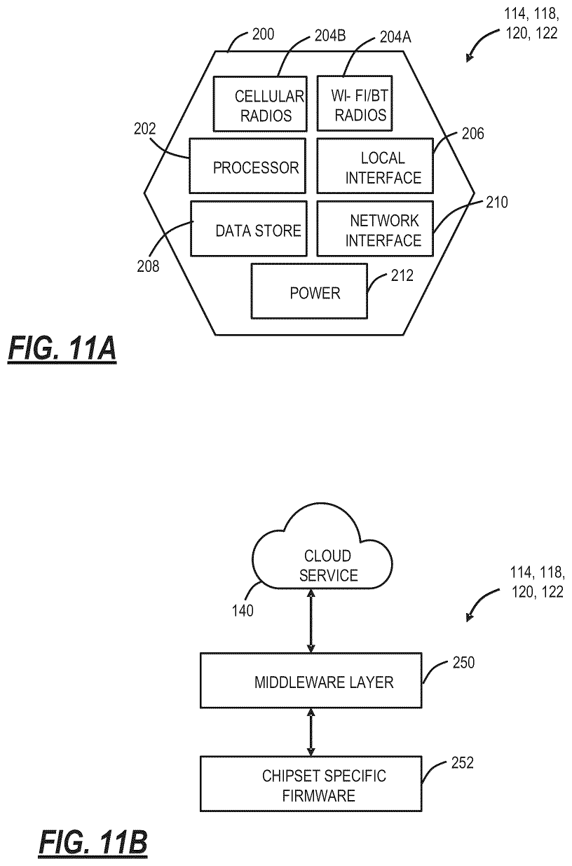

FIG. 11A is a block diagram of functional components of the access points 114, mesh nodes 118, repeaters 120, etc. (“node”) in the Wi-Fi networks 110. The node includes a physical form factor 200 which contains a processor 302, a plurality of radios 204A, 104B, a local interface 306, a data store 308, a network interface 210, and power 212. It should be appreciated by those of ordinary skill in the art that FIG. 11A depicts the node in an oversimplified manner, and a practical embodiment may include additional components and suitably configured processing logic to support features described herein or known or conventional operating features that are not described in detail herein.

In an embodiment, the form factor 200 is a compact physical implementation where the node directly plugs into an electrical socket and is physically supported by the electrical plug connected to the electrical socket. This compact physical implementation is ideal for a large number of nodes distributed throughout a residence. The processor 302 is a hardware device for executing software instructions. The processor 302 can be any custom made or commercially available processor, a central processing unit (CPU), an auxiliary processor among several processors, a semiconductor-based microprocessor (in the form of a microchip or chipset), or generally any device for executing software instructions. When the node is in operation, the processor 302 is configured to execute software stored within memory or the data store 308, to communicate data to and from the memory or the data store 308, and to generally control operations of the access point 114 pursuant to the software instructions. In an embodiment, the processor 302 may include a mobile optimized processor such as optimized for power consumption and mobile applications.

The radios 204A enable wireless communication in the Wi-Fi network 110. The radios 204B can operate according to the IEEE 802.11 standard. The radios 204B support cellular connectivity such as Long-Term Evolution (LTE), 5G, and the like. The radios 204A, 104B include address, control, and/or data connections to enable appropriate communications on the Wi-Fi network 110 and a cellular network, respectively. As described herein, the node can include a plurality of radios 204A to support different links, i.e., backhaul links and client links. The radios 204A can also include Wi-Fi chipsets configured to perform IEEE 802.11 operations. In an embodiment, an optimization can determine the configuration of the radios 204B such as bandwidth, channels, topology, etc. In an embodiment, the node supports dual-band operation simultaneously operating 2.4 GHz and 5 GHz 2×2 MIMO 802.11b/g/n/ac radios having operating bandwidths of 20/40 MHz for 2.4 GHz and 20/40/80 MHz for 5 GHz. For example, the node can support IEEE 802.11AC1200 gigabit Wi-Fi (300+867 Mbps). Also, the node can support additional frequency bands such as 6 GHz, as well as cellular connections. The radios 204B can include cellular chipsets and the like to support fixed wireless access.

Also, the radios 204A, 104B include antennas designed to fit in the form factor 200. An example is described in commonly-assigned U.S. patent Ser. No. 17/857,377, entitled “Highly isolated and barely separated antennas integrated with noise free RF-transparent Printed Circuit Board (PCB) for enhanced radiated sensitivity,” filed Jul. 5, 2022, the contents of which are incorporated by reference in their entirety.

The local interface 306 is configured for local communication to the node and can be either a wired connection or wireless connection such as Bluetooth or the like. Since the node can be configured via the cloud service 140, an onboarding process is required to first establish connectivity for a newly turned on node. In an embodiment, the node can also include the local interface 306 allowing connectivity to a Wi-Fi client device 116 for onboarding to the Wi-Fi network 110 such as through an app on the user device 116. The data store 308 is used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media.

The network interface 210 provides wired connectivity to the node. The network interface 210 may be used to enable the node communicates to the modem/router 130. Also, the network interface 210 can be used to provide local connectivity to a Wi-Fi client device 116 or another access point 122. For example, wiring in a device to a node can provide network access to a device that does not support Wi-Fi. In an embodiment, all of the nodes in the Wi-Fi network 110D include the network interface 210. In another embodiment, select nodes, which connect to the modem/router 130 or require local wired connections have the network interface 210. The network interface 210 may include, for example, an Ethernet card or adapter (e.g., 10BaseT, Fast Ethernet, Gigabit Ethernet, 10 GbE). The network interface 210 may include address, control, and/or data connections to enable appropriate communications on the network.

The processor 302 and the data store 308 can include software and/or firmware which essentially controls the operation of the node, data gathering and measurement control, data management, memory management, and communication and control interfaces with the cloud service 140. The processor 302 and the data store 308 may be configured to implement the various processes, algorithms, methods, techniques, etc. described herein.

Also, those skilled in the art will appreciate there can be various physical implementations which are contemplated herein. For example, in some embodiments, the modem/router 130 can be integrated with the access point 114, 18, 22. In other embodiments, just a router can be integrated with the access point 114, 18, 22 with separate connectivity to a modem.

### § 8.1 OpenSync

FIG. 11B is a logical diagram of the access points 114, mesh nodes 118, repeaters 120, etc. (“node”) with a middleware layer 250 to enable operation with the cloud service 140. Of note, the present disclosure contemplates use with any vendor's hardware for the access points 114, mesh nodes 118, repeaters 120, etc. with the addition of the middleware layer 250 that is configured to operate with chipset specific firmware 252 in the node. In an embodiment, the middleware layer 250 is OpenSync, such as describe in www.opensync.io/documentation, the contents of which are incorporated by reference. Again, OpenSync is cloud-agnostic open-source software for the delivery, curation, and management of services for the modern home. That is, this provides standardization of the communication between devices and the cloud service 140. OpenSync acts as silicon, Customer Premises Equipment (CPE), and cloud-agnostic connection between the in-home hardware devices and the cloud service 140.

The middleware layer 250 spans across layers from just above the firmware drivers to the cloud connection for the cloud service 140. The middleware layer 250 is software operates with the following device segments:

### Measurements/Statistics/Telemetry

Collecting measurements reported by the low-level drivers
Compiling and pre-processing the measurements into statistics that are uniform across different devices
Presenting the statistics using standardized formats
Preparing the formatted statistics for transfer to the cloud using serialization and packetizing
Communicating the statistics to the cloud using standardized and efficient telemetry

### Management/Control

Defining a standard interface for control messaging from the cloud service 140
Providing operations necessary to manage the services, such as onboarding and provisioning
Providing rules-based networking configurations to block, filter, forward, and prioritize the messages
Implementing software to manage the device maintenance functions, including logging, firmware upgrades, and debugging

### Cloud-Managed Services

Wi-Fi, including mesh networks that dynamically adapt to their environments
User access management
Cybersecurity
Parental controls
IoT device management
Additional services

Through use of the middleware layer 250, it is possible to have various different vendor devices operate with the cloud service 140.

### § 88.2 Virtual Network Functions (VNF) on the Access Points

In addition to the middleware layer 250, the present disclosure contemplates the ability for the cloud service 140 to add applications, features, etc. on the nodes. In the present disclosure, the node is configured to maintain tunnels to the corporate network as well as support forwarding based on virtual networks.

### § 8.3 SDN and OpenFlow

In an embodiment, the cloud service 140 can use software defined network (SDN) such as via OpenFlow to control the Wi-Fi networks 110 and the corresponding access points. OpenFlow is described at opennetworking.org and is a communications protocol that gives access to the forwarding plane of a network switch or router over the network. In this case, the forwarding plane is with the access points and the network is the Wi-Fi network 110. The access points and the cloud service can include with OpenFlow interfaces and Open vSwitch Database Management Protocol (OVSDB) interfaces. The cloud service 140 can use a transaction oriented reliable communication protocol such as Open vSwitch Database Management Protocol (OVSDB) to interact with the Wi-Fi networks 110.

The present disclosure includes multiple virtual networks in the Wi-Fi network 110 and one implementation can include SDN such as via OpenFlow.

### § 9.0 Cloud Server and User Device

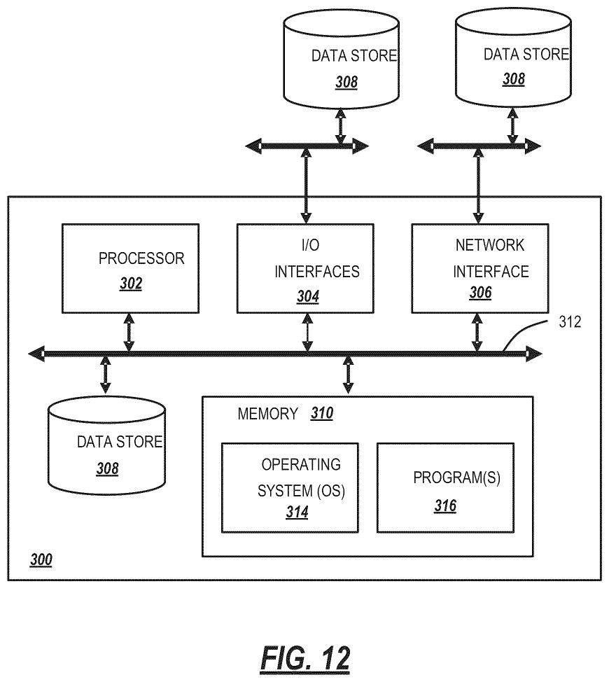

FIG. 12 is a block diagram of functional components of a server 300, a Wi-Fi client device 116, or a user device that may be used with the Wi-Fi network of FIG. 9 or 2B, and/or the cloud-based control of FIG. 10A. The server 300 may be a digital computer that, in terms of hardware architecture, generally includes a processor 302, input/output (I/O) interfaces 304, a network interface 306, a data store 308, and memory 310. It should be appreciated by those of ordinary skill in the art that FIG. 12 depicts the server 300 in an oversimplified manner, and a practical embodiment may include additional components and suitably configured processing logic to support features described herein or known or conventional operating features that are not described in detail herein.

The components (202, 204, 206, 208, and 210) are communicatively coupled via a local interface 212. The local interface 212 may be, for example, but not limited to, one or more buses or other wired or wireless connections, as is known in the art. The local interface 212 may have additional elements, which are omitted for simplicity, such as controllers, buffers (caches), drivers, repeaters, and receivers, among many others, to enable communications. Further, the local interface 212 may include address, control, and/or data connections to enable appropriate communications among the aforementioned components.

The processor 302 is a hardware device for executing software instructions. The processor 302 may be any custom made or commercially available processor, a central processing unit (CPU), an auxiliary processor among several processors associated with the server 300, a semiconductor-based microprocessor (in the form of a microchip or chipset), or generally any device for executing software instructions. When the server 300 is in operation, the processor 302 is configured to execute software stored within the memory 310, to communicate data to and from the memory 310, and to generally control operations of the server 300 pursuant to the software instructions. The I/O interfaces 304 may be used to receive user input from and/or for providing system output to one or more devices or components. The user input may be provided via, for example, a keyboard, touchpad, and/or a mouse. System output may be provided via a display device and a printer (not shown). I/O interfaces 304 may include, for example, a serial port, a parallel port, a small computer system interface (SCSI), a serial ATA (SATA), a fiber channel, InfiniBand, ISCSI, a PCI Express interface (PCI-x), an infrared (IR) interface, a radio frequency (RF) interface, and/or a universal serial bus (USB) interface.

The network interface 306 may be used to enable the server 300 to communicate on a network, such as the cloud service 140. The network interface 306 may include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n/ac). The network interface 306 may include address, control, and/or data connections to enable appropriate communications on the network. A data store 308 may be used to store data. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media. In one example, the data store 308 may be located internal to the server 300 such as, for example, an internal hard drive connected to the local interface 212 in the server 300. Additionally, in another embodiment, the data store 308 may be located external to the server 300 such as, for example, an external hard drive connected to the I/O interfaces 304 (e.g., SCSI or USB connection). In a further embodiment, the data store 308 may be connected to the server 300 through a network, such as, for example, a network-attached file server.

The memory 310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 310 may incorporate electronic, magnetic, optical, and/or other types of storage media. Note that the memory 310 may have a distributed architecture, where various components are situated remotely from one another but can be accessed by the processor 302. The software in memory 310 may include one or more software programs, each of which includes an ordered listing of executable instructions for implementing logical functions. The software in the memory 310 includes a suitable operating system (O/S) 314 and one or more programs 316. The operating system 214 essentially controls the execution of other computer programs, such as the one or more programs 316, and provides scheduling, input-output control, file and data management, memory management, and communication control and related services. The one or more programs 316 may be configured to implement the various processes, algorithms, methods, techniques, etc. described herein, such as related to the optimization.

§ 10.0 Wi-Fi Network with Wired and Wireless Connectivity

Again, the wireless access points 114, 18, 22 include both the Wi-Fi radios 204A, the cellular radios 204B, and the network interface 210. The network interface 210 can include an Ethernet connection to the modem/router 130. In an embodiment, the cellular radios 204B can provide a backup connection to the Ethernet connection, for connectivity to the Internet. Of note, the access point 114, 18, 22 with the cellular radios 204B can be referred to as a gateway 30A node. That is, the term gateway 30A is meant to cover any access point 114, 18, 22, modem/router, etc. or combination thereof that enables connectivity to the Internet 112 for the Wi-Fi network 110. Note, in some embodiments, a modem is separate from the access point 114, 18, 22. In other embodiments, the access point 114, 18, 22, include a router. In still other embodiments, the access point 114, 18, 22 can include a modem/router. Those skilled in the art will recognize various approaches are contemplated and all such equivalents are considered herewith.

FIG. 5 is a network diagram of a portion of a network 300 associated with a network operator. In this example, the network operator includes both wired and wireless broadband in the same geographical area, represented by homes 302. For example, the wired broadband can be via modems/routers 30 that can connect ultimately to a cable modem termination system (CMTS) 304 (or some other type of wired infrastructure, e.g., DSL, Passive Optical Network (PON), Hybrid Fiber Coax (HFC), etc.), and the wireless broadband can be via fixed wireless access via the cellular radios 204B in the access points 114, 18, 22 that connect to a base station 306 (e.g., eNodeB, gNodeB, etc.). It would be advantageous to support failover to the wireless broadband in the case of a wired broadband failure, providing reliability, uptime, and high service level agreement (SLA) support. In the case of a single outage, this is not an issue on the wireless network. However, often wired failures are geographically localized. For example, failure of the CMTS 304 causes a burden on the base station 306 because the wired broadband failure is geographically localized to the homes 302. This could dramatically put a burden on the base station 306 or other cellular cells in the area, leading to degradation of services for all mobile users in the area. That is, wired broadband outages tend to be localized and using wireless broadband for failover could inundate the cellular network.

### § 10.1 Fixed Wireless Access System

FIG. 6 is a diagram of a fixed wireless access system 400 for wired and/or wireless connectivity. For illustration purposes, the fixed wireless access system 400 is illustrated with a single home 302 having a modem/router 130 and a Wi-Fi client device 116. Those skilled in the art will recognize the fixed wireless access system 400 contemplates multiple locations, including homes, businesses, store, library, mall, sporting area, or any location where a Wi-Fi network 110 is deployed. Further, the fixed wireless access system 400 contemplates use with various different Wi-Fi networks 110, with various different network operators, etc. Also, the fixed wireless access system 400 contemplates use with any of the various wired and/or wireless connectivity schemes described herein.

The cloud service 140 is configured to connect to the Wi-Fi network 110, either via a wired connection 402 and/or a wireless connection 404. In an embodiment, the cloud service 140 can be utilized for configuration, monitoring, and reporting of the Wi-Fi networks 110 in the homes or other locations. The cloud service 140 can be configured to detect outages such as for the wired connections 402. For example, this functionality is described in commonly-assigned U.S. patent application Ser. No. 17/700,782, filed Mar. 22, 2022, and entitled “Intelligent monitoring systems and methods for Wi-Fi Metric-Based ISP Outage Detection for Cloud Based Wi-Fi Networks,” the contents of which are incorporated by reference in their entirety.

Also, the cloud service 140 can connect to a 5G cloud control plane 410 and can determine 5G to Wi-Fi quality of experience (QoE) monitoring and application prioritization controls for increased service consistency. QoE analytics can be shared with 5G cloud control plane 410 for network optimization feedback.

In an embodiment, the access points 114, 118, 120, 122 and/or gateway 130A can include OpenSync support for communicating with the cloud service 140.

### § 11.0 Conclusion

It will be appreciated that some exemplary embodiments described herein may include one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application-Specific Integrated Circuits (ASICs), in which each function or some combinations of certain of the functions are implemented as custom logic or circuitry. Of course, a combination of the aforementioned approaches may be used. For some of the exemplary embodiments described herein, a corresponding device in hardware and optionally with software, firmware, and a combination thereof can be referred to as “circuitry configured or adapted to,” “logic configured or adapted to,” etc. perform a set of operations, steps, methods, processes, algorithms, functions, techniques, etc. on digital and/or analog signals as described herein for the various exemplary embodiments.

Moreover, some exemplary embodiments may include a non-transitory computer-readable storage medium having computer readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), Flash memory, and the like. When stored in the non-transitory computer-readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various exemplary embodiments.

The foregoing sections include headers for various embodiments and those skilled in the art will appreciate these various embodiments may be used in combination with one another as well as individually. Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims.

1. A wireless consumer-electronic device comprising:
an outer housing;
electronic circuitry arranged within the outer housing for performing one or more electronic functions;
a power source arranged within the outer housing, the power source configured to be charged wirelessly; and
a movement action mechanism arranged within the outer housing, the movement action mechanism configured to enable the wireless consumer-electronic device to levitate.

2. The wireless consumer-electronic device of claim 1, wherein the electronic circuitry includes Wi-Fi communication capabilities, and wherein the outer housing includes a common size and/or shape of a Wi-Fi device.

3. The wireless consumer-electronic device of claim 2, wherein the wireless consumer-electronic device is an Access Point (AP) device, a Wi-Fi pod device, a Wi-Fi leaf device, or a Wi-Fi extender and is configured to extend the range of Wi-Fi accessibility by communicating Wi-Fi signals intermediately between a user device and a Wi-Fi router over backhaul and fronthaul links.

4. The wireless consumer-electronic device of claim 1, wherein the movement action mechanism is further configured to enable the wireless consumer-electronic device to rotate while in a levitated position.

5. The wireless consumer-electronic device of claim 4, wherein the movement action mechanism is configured to operate in conjunction with a base station device for levitating and rotating the wireless consumer-electronic device.

6. The wireless consumer-electronic device of claim 5, further comprising one or more antennas and one or more radios, wherein the movement action mechanism and base station device are configured to rotate the wireless consumer-electronic device in order to strategically steer the one or more antennas for increasing the strength of wireless communication signals, for increasing wireless coverage, and/or for reducing signal interference.

7. The wireless consumer-electronic device of claim 1, wherein the power source comprises a rechargeable battery unit and is configured to operate in conjunction with a base station device for charging the rechargeable battery unit.

8. The wireless consumer-electronic device of claim 7, wherein the power source and base station device utilize magnetic induction for charging the rechargeable battery unit.

9. The wireless consumer-electronic device of claim 1, wherein the movement action mechanism is configured to move the wireless consumer-electronic device in vertical and horizontal directions to enable self-positioning of the wireless consumer-electronic device within an area.

10. The wireless consumer-electronic device of claim 9, wherein the electronic circuitry includes wireless communication capabilities, and wherein the movement action mechanism is configured to move the wireless consumer-electronic device to a location and/or orientation for increasing the strength or coverage of wireless communication signals and/or for reducing wireless communication interference.

11. The wireless consumer-electronic device of claim 9, further comprising one or more sensors for sensing obstacles while the movement action mechanism is moving the wireless consumer-electronic device, wherein the electronic circuitry includes navigation functionality to help the movement action mechanism avoid the sensed obstacles.

12. The wireless consumer-electronic device of claim 9, wherein self-positioning the wireless consumer-electronic device includes landing the wireless consumer-electronic device on a base station device selected from one or more base station devices to enable the power source to be wirelessly recharged.

13. The wireless consumer-electronic device of claim 1, further comprising a speaker driver arranged within the outer housing, wherein, when the wireless consumer-electronic device is positioned on an external object having a flat surface, the speaker driver is configured to vibrate the external object to generate sound.

12-13. (canceled)

14. The wireless consumer-electronic device of claim 1, further comprising one or more audio and/or visual output devices configured to indicate when a power level of the power source is low, when the strength of a wireless link is low, and/or when an Internet connection is down.

15. A system comprising:
one or more base station devices; and
one or more wireless consumer-electronic devices, wherein each wireless consumer-electronic device includes:
an outer housing,
electronic circuitry arranged within the outer housing for performing one or more electronic functions,
a power source arranged within the outer housing, the power source configured to be charged wirelessly by a nearby base station device of the one or more base station devices, and
a movement action mechanism arranged within the outer housing, the movement action mechanism and nearby base station device configured to enable the wireless consumer-electronic device to levitate.

16. The system of claim 15, further comprising a Wi-Fi router configured to establish a Wi-Fi network, wherein the one or more wireless consumer-electronic devices include a plurality of Wi-Fi Access Point (AP) devices, and wherein the Wi-Fi router is configured to determine the status of the Wi-Fi network to calculate locations of the Wi-Fi AP devices to increase Wi-Fi signal strength and/or reduce Wi-Fi signal interference.

17. The system of claim 16, wherein the movement action mechanism of each Wi-Fi AP device is configured to automatically position the respective Wi-Fi AP device to one of the calculated locations.

18. The system of claim 16, wherein one or more of the Wi-Fi AP devices acts as an intermediate device between the Wi-Fi router and one or more other Wi-Fi AP devices to extend the reach of the Wi-Fi network.

19. The system of claim 15, wherein each base station device includes:
one or more magnets and/or electromagnets for enabling a nearby wireless consumer-electronic device to levitate;
one or more charging coils for wirelessly charging the nearby wireless consumer-electronic device;
a magnetic gear device configured to rotate the nearby wireless consumer-electronic device to a predetermined rotational orientation.

20. The system of claim 19, wherein nearby wireless consumer-electronic device includes a directional Wi-Fi antenna, and wherein the predetermined rotational orientation
is based on steering the directional Wi-Fi antenna in a direction to increase Wi-Fi signal strength and/or reduce Wi-Fi signal interference.

21-24. (canceled)
